(19) United States
(12) Patent Application Publication
(10) Pub. No.: US 2019/0353313 A1
(43) Pub. Date: Nov. 21, 2019

(54) OPTICALLY AND THERMALLY EFFICIENT LIGHT BARS AND FIXTURES PROVIDING LIGHT FIDELITY WIRELESS COMMUNICATIONS

(71) Applicant: LINMORE LED LABS, INC., Fresno, CA (US)

(72) Inventors: Paul Chamberlain, Fresno, CA (US); John Gilmore, Fresno, CA (US); Cooper Wallace, Fresno, CA (US)

(21) Appl. No.: 16/415,786

(22) Filed: May 17, 2019

Related U.S. Application Data
(60) Provisional application No. 62/673,364, filed on May 18, 2018.

(51) Int. Cl. F21S 4/28; F21V 29/61; F21V 21/30; H01R 25/14

(52) U.S. Cl. CPC F21S 4/28; H01R 25/14; F21V 21/30; F21V 29/61

(57) ABSTRACT

Optically and thermally efficient light bars and light fixtures which are uniquely configured to provide light fidelity (Li-Fi) wireless communications. In a first embodiment, an LED light bar is outfitted with components adapted to provide Li-Fi wireless communications, while further being configured to provide superior heat dissipation characteristics and adapted for retrofit applications in substitution for any one of a variety of linear fluorescent light fixtures. In a second embodiment, an LED light fixture, potentially suitable for use in high bay or ceiling applications, is outfitted with components adapted to provide Li-Fi wireless communications, while further being configured to provide superior heat dissipation and light emission/distribution characteristics and also adapted for retrofit applications in substitution for any one of a variety of conventional linear fluorescent and non-LED light fixtures.

### CROSS-REFERENCE TO RELATED APPLICATIONS

The present application claims priority to U.S. Provisional Patent Application Ser. No. 62/673,364 filed May 18, 2018, the disclosure of which is incorporated herein by reference.

### STATEMENT RE: FEDERALLY SPONSORED RESEARCH/DEVELOPMENT

Not Applicable

### BACKGROUND

### 1. Field of the Invention

The present disclosure relates generally to lighting systems and, more particularly, to optically and thermally efficient light bars and light fixtures which are uniquely configured to provide light fidelity (Li-Fi) wireless communications. In a first embodiment, an LED light bar is outfitted with components adapted to provide Li-Fi wireless communications, while further being configured to provide superior heat dissipation characteristics and adapted for retrofit applications in substitution for any one of a variety of linear fluorescent light fixtures. In a second embodiment, an LED light fixture, potentially suitable for use in high bay or ceiling applications, is outfitted with components adapted to provide Li-Fi wireless communications, while further being configured to provide superior heat dissipation and light emission/distribution characteristics and also adapted for retrofit applications in substitution for any one of a variety of conventional linear fluorescent and non-LED light fixtures.

### 2. Description of the Related Art

The use of LED (Light Emitting Diode) lights is becoming increasingly popular in a wide variety of lighting applications. Significant advances have been made in LED lighting technology, which has made the use of LED lights more affordable and desirable in various industrial, household, and other environments requiring expanded lighting systems.

LED lights are generally viewed as offering significant advantages over traditional incandescent lighting systems. With incandescent bulbs, the expense is not only the cost of replacement bulbs, but the labor and costs associated with frequent replacement of the bulbs. This expense can be significant where there are a large number of installed bulbs. For example, the high maintenance costs typically incurred to replace bulbs in large office buildings, commercial warehouses, and the like are substantially minimized with LED lighting systems. In addition, the operational life of conventional white LED lamps is about 100,000 hours, which is a drastic increase over the average life of an incandescent bulb, which is approximately 5000 hours. Thus, the use of LED lights virtually eliminates the need for routine bulb replacement, this advantage being even more important when the lighting device is embedded or located in a relatively inaccessible place. Still further, it is generally recognized that, in a properly designed system, LED lights consume significantly less power than incandescent bulbs. In greater detail, an LED circuit has an efficiency of about 80%, meaning that about 80% of the electrical energy is converted to light energy, while the remaining 20% is lost as heat energy. As will be recognized, this efficiency facilitates significant cost savings in large lighting systems.

However, due in part to the relatively high cost of LED lights, the art turned to fluorescent light bulbs and systems as an alternative to incandescent lights. Generally speaking, fluorescent lighting is significantly less costly than incandescent lighting while providing essentially the same brightness, and also lasts longer than conventional incandescent lighting. In greater detail, on average, a fluorescent tube has a lifespan of about six times longer than a regular incandescent bulb. Because of these advantages, a vast majority of commercial and industrial structures incorporate conventional fluorescent light bar fixtures.

Fluorescent lights, however, have distinct disadvantages which detract from their overall utility. In greater detail, fluorescent lighting circuits are more complex than incandescent lighting and generally require professional installation and expensive components. In addition, fluorescent lighting is generally less attractive than incandescent lighting and can flicker noticeably, while also producing an uneven light. Mercury is also an essential component in the manufacturing of fluorescent light tubes, and is considered hazardous by the U.S. Environmental Protection Agency due to its ability to bio-accumulate within the environment. Along these lines, the disposal of fluorescent light tubes is problematic for many municipalities.

The aforementioned drawbacks associated with the use fluorescent lighting have resulted in an increased reliance on LED lighting, with the use LED light bars as an alternative to fluorescent light tubes becoming more prevalent as the costs of LED lighting continue to decrease in the marketplace. However, the cost of replacing existing fluorescent light tube fixtures and circuitry in existing structures, systems, and so forth, is still relatively high. These costs are sometimes escalated by the designs of known LED lighting bars not being well suited for quick and easy retrofit installation, and further not being adapted for optimal heat dissipation and/or optimal light emission/distribution. These deficiencies as they relate to heat dissipation may result in the need to provide ancillary modalities to facilitate adequate heat dissipation. These deficiencies as they relate to light emission/distribution are particularly prevalent in “high bay” applications wherein the floor to light fixture separation distance is twenty (20) feet or more.

While LED lighting has been found to overcome many of the drawbacks of fluorescent lighting as indicated above, it has also been found to offer other significant benefits. In greater detail, a currently known, rapidly evolving technology is light fidelity or “Li-Fi” wireless communications. This optical wireless communications technology uses light from light-emitting diodes (LEDs) as a medium to deliver networked, mobile, high-speed communication in a similar manner to wireless fidelity or “Wi-Fi.” Visible light communications works by switching the current to the LEDs off and on at a very high rate, too quick to be noticed by the human eye. The light waves cannot penetrate walls which makes a much shorter range, though more secure from hacking, relative to Wi-Fi. However, direct line of sight is not necessary for Li-Fi to transmit a signal, as light reflected off the walls can still achieve data a reasonably high level of data transmission. While both Wi-Fi and Li-Fi transmit data over the electromagnetic spectrum, Wi-Fi utilizes radio waves, whereas Li-Fi uses visible light, ultraviolet and infrared. While the US Federal Communications Commission has warned of a potential spectrum crisis because Wi-Fi is close to full capacity, Li-Fi has almost no limitations on capacity, as the visible light spectrum is about 10,000 times larger than the entire radio frequency spectrum. Researchers have reached data rates of over 224 Gbit/s, and Li-Fi is expected to be significantly less expensive than Wi-Fi. At present, the primary downsides associated with Li-Fi are short range, potentially low reliability, and high installation costs.

Thus, there is thus a need for an LED lighting system which captures and provides all of the aforementioned benefits, such as one including an LED light bar that is outfitted with components adapted to provide Li-Fi wireless communications, can easily and affordably be used in retrofit applications in substitution for conventional fluorescent light fixtures, and is provided with superior heat dissipation structural features as well as superior light emission/distribution structural features as optimizes its utility for use Li-Fi applications, particularly when used in high ceiling applications. These, as well as other features and advantages are provided by the present disclosure as will be described in more detail below.

### BRIEF SUMMARY

In accordance with the present disclosure, in a first embodiment, there is provided a heat dissipating LED light bar which may be used as part of a complete retrofit system for a variety of linear fluorescent light fixtures, and is outfitted with various components adapted to provide Li-Fi wireless communications. It is contemplated that the LED light bar of the first embodiment may be provided in one of several nominal lengths (e.g., about 21 inches and about 45 inches) to retrofit the most popularly installed fluorescent light fixtures. The LED light bar comprises, among other things, an elongate channel member which is preferably fabricated from extruded aluminum (e.g., 6063 T5 aluminum). In addition to the channel member, the LED light bar comprises a high-efficacy set of LEDs, which are preferably provided in the form of an elongate LED printed circuit board (PCB) or strip. In greater detail, the LED strip may comprise an aluminum core which is mechanically bonded to the channel member, and has a multiplicity of LEDs (e.g., from 144 to 288) disposed thereon in a prescribed pattern or arrangement (e.g., two side-by-side rows). However, the aluminum strip may also be outfitted with a single row of LEDs numbering from 60 to 120. In addition to the LEDs, the LED strip preferably includes a plurality of metal-oxide-semiconductor field-effect transistors (MOSFETs) integrated therein as modalities to help facilitate the Li-Fi functionality of the light bar.

The LED light bar further comprises an integral volumetric diffuser which is coupled to the channel member and effectively covers or shields the LED strip. The volumetric diffuser is optional, and may not necessarily be included with the LED light bar. If included, the diffuser is adapted to eliminate glare and evenly distribute light, transmitting about 95% of the generated lumens from the LED strip, with the beam angle generated by the LED light bar being about 180° for a wide distribution of light. The LED light bar is further glass free based on the preferred material for the diffuser. The LED light bar may further comprise an external dimmable driver which electrically communicates with the LED strip.

The channel member of the LED light bar is outfitted with fins and other surface features uniquely configured to provide superior heat dissipation, thus allowing the channel member to effectively function as a heat sink for the LED strip, and to other components which may be accommodated within an elongate interior chamber defined thereby. Along these lines, the channel member is configured to provide or define a first air flow cavity under the LED strip as allows for the effective dissipation of heat during operation of the LED light bar. This first air flow cavity is effectively defined between the LED strip and the aforementioned interior chamber which may be used to accommodate a power supply/driver and/or other hardware (e.g., a router or switch) necessary to impart Li-Fi wireless communications transmission capability to the LEDs of the LED strip. In addition to the first air flow cavity, the channel member is configured to provide or define a second air flow cavity, the first and second air flow cavities extending along the lengths of respective ones of opposed sides of the interior chamber. The size and placement of the first and second air flow cavities relative to the interior chamber allows for the effective dissipation of heat from any components housed within the interior chamber during operation of the LED light bar. The preferred mechanical bonding of the interior LED strip to the channel member, and placement of other components into the interior chamber, maximizes the efficacy or functionality of the channel member as a heat sink.

The LED light bar is further preferably outfitted with an identically pair of end caps which are cooperatively engaged to respective ones of the opposed ends of the channel member. The end caps are configured to provide open fluid communication between the first and second air flow cavities and ambient air, and between the interior chamber and ambient air. Each end cap may further be outfitted with suitable modalities to facilitate the retrofit attachment of the LED light bar to an underlying support surface, or to a socket (e.g., tombstone) of an existing fixture adapted to accommodate a fluorescent tube.

In a second embodiment, there is provided a heat dissipating LED light fixture which may also be used as part of a complete retrofit system for a variety of linear fluorescent light fixtures, as is particularly suited for optional use in high bay installation applications. The LED light fixture of the second embodiment comprises, among other things, an elongate channel member which is preferably fabricated from extruded aluminum (e.g., 6063 T5 aluminum). In addition to the channel member, the LED light fixture comprises a high-efficacy set of LEDs, which are preferably provided in the form of an elongate LED printed circuit board (PCB) or strip. In greater detail, the LED strip preferably comprises an aluminum core which is mechanically bonded to the channel member, and has a multiplicity of LEDs disposed thereon in a prescribed pattern or arrangement (e.g., two side-by-side rows). In addition to the LEDs, the LED strip preferably includes a plurality of metal-oxide-semiconductor field-effect transistors (MOSFETs) integrated therein as modalities to help facilitate the Li-Fi functionality of the light fixture.

The channel member of the LED light fixture is outfitted with fins and other surface features uniquely configured to provide superior heat dissipation, thus allowing the channel member to effectively function as a heat sink for the LED strip, and to other components which may be accommodated within an elongate interior chamber defined thereby. Along these lines, the channel member is configured to provide or define a first air flow cavity under the LED strip as allows for the effective dissipation of heat during operation of the LED light fixture. This first air flow cavity is effectively defined between the LED strip and the aforementioned interior chamber which may be used to accommodate a power supply/driver and/or other hardware (e.g., a router or switch) necessary to impart Li-Fi wireless communications transmission capability to the LEDs of the LED strip. In addition to the first air flow cavity, the channel member is configured to provide or define a second air flow cavity, the first and second air flow cavities extending along the lengths of respective ones of opposed sides of the interior chamber. The size and placement of the first and second air flow cavities relative to the interior chamber allows for the effective dissipation of heat from any components housed within the interior chamber during operation of the LED light fixture. The preferred mechanical bonding of the interior LED strip to the channel member, and placement of other components into the interior chamber, maximizes the efficacy or functionality of the channel member as a heat sink

The channel member of the LED light fixture bar is further outfitted with a generally parabolic reflector portion which is itself uniquely configured to provide optimal light emission/distribution characteristics. In greater detail, reflector portion comprises two identically configured side sections which are integral portions of the channel member extending below the LED strip in spaced, opposed relation to each other. The structural features/contours of the reflector portion are designed to optimize the amount and consistency of distribution of the light emitted from the LED light fixture. As will be recognized, in the context of Li-Fi wireless communications, the transmission optimization facilitated by the reflector portion is a key attribute of ensuring the efficacy, efficiency, and reliability of such communications. In this regard, the objective of the design is to get as much light as possible directed downward based on fixture mounting heights starting at about 10 feet, and up to about 20 feet or more. Along these lines, the present disclosure provides a first iteration of the reflector portion which is uniquely contoured to maximize light transmission at light fixture mounting heights of about 20 feet, with a second iteration of the reflector portion also being provided which is uniquely contoured to maximize light transmission at light fixture mounting heights of about 10 feet. It is also contemplated that the light transmission maximization attributes of the reflector portion may also be achievable by providing the same with a shape other than for a parabolic shape.

In either of the first and second iterations of the reflector portion, the distance the side sections are separated from each other, the parabolic shape of the reflector portion, the rate at which the side sections get farther apart as they extend downward, and how far the side sections extend downward are all optimized to achieve the aforementioned objectives. The light emitted is projected downward or is reflected off the interior surfaces of the side sections of the reflector portion. The curvature of the parabolic shaped side sections is further optimized to get light out of the reflector portion after only one bounce off of the reflector, as opposed to reflecting from one side section to the other side section, as each bounce of light decreases the light that is able to reach the work surface. It is contemplated that the interior, inwardly facing surfaces of the side sections may each have a sheet like insert applied thereto, these inserts each comprising a 98% reflective material to maximize the amount of light projected from the reflector portion. However, the inserts are optional, and need not be included with the reflector portion. The distal edge of each of the side sections may be formed to include an elongate slot, these slots extending in spaced, opposed relation to each other and accommodating the optional insertion of a diffuser material to reduce glare.

The LED light fixture is further preferably outfitted with an identically pair of end caps which are cooperatively engaged to respective ones of the opposed ends of the channel member. The end caps are configured to provide open fluid communication between the first and second air flow cavities and ambient air, and between the interior chamber and ambient air. Each end cap may further be outfitted with suitable modalities to facilitate the retrofit attachment of the LED light fixture to an underlying support surface, or to a socket (e.g., tombstone) of an existing fixture adapted to accommodate a fluorescent tube.

It is further contemplated that that one or more light bars of the first embodiment, or one or more light fixtures of the second embodiment, may be mounted to a common substrate or other support surface, which is in turn adapted to be mounted to a support surface such as a ceiling in a non-retrofit application. In this arrangement, it is also contemplated that a Li-Fi related component such as an access point (AP) box may be mounted to the common substrate proximate to the light bar or light fixture.

The present disclosure is best understood by reference to the following detailed description when read in conjunction with the accompanying drawings.

### BRIEF DESCRIPTION OF THE DRAWINGS

These, as well as other features of the present disclosure, will become more apparent upon reference to the drawings wherein:

FIG. 1 is a top perspective view of an exemplary assembly comprising two LED light bars mounted to a common substrate, each of the light bars being constructed in accordance with a first embodiment of the present disclosure;

FIG. 2 is perspective, cross-sectional view of the assembly shown in FIG. 1;

FIG. 3 is a top perspective view of the channel member of the LED light bar of the first embodiment;

FIG. 4 is a cross-sectional view of the channel member of the LED light bar of the first embodiment shown in FIG. 3;

FIG. 5 is a top perspective view of one of the identically configured pair of end caps integrated into the LED light bar of the first embodiment;

FIG. 6 is a top perspective view of the LED strip integrated into the LED light bar of the first embodiment;

FIG. 7 is a top perspective view of an exemplary assembly comprising two LED light fixtures mounted to a common substrate, each of the light fixtures being constructed in accordance with a second embodiment of the present disclosure;

FIG. 8 is perspective, cross-sectional view of the assembly shown in FIG. 7;

FIG. 9 is a top perspective view of a first exemplary version of the channel member of the LED light fixture of the second embodiment;

FIG. 10 is a cross-sectional view of the first exemplary version of the channel member of the LED light fixture of the second embodiment shown in FIG. 9;

FIG. 11 is a top perspective view of one of the identically configured pair of end caps which may be integrated into the LED light fixture of the second embodiment and adapted for use in conjunction with the first exemplary version of the channel member;

FIG. 12 is a top perspective view of a second exemplary version of the channel member of the LED light fixture of the second embodiment;

FIG. 13 is a cross-sectional view of the second exemplary version of the channel member of the LED light fixture of the second embodiment shown in FIG. 12; and

FIG. 14 is a top perspective view of one of the identically configured pair of end caps which may be integrated into the LED light fixture of the second embodiment and adapted for use in conjunction with the second exemplary version of the channel member.

Common reference numerals are used throughout the drawings and detailed description to indicate like elements.

### DETAILED DESCRIPTION

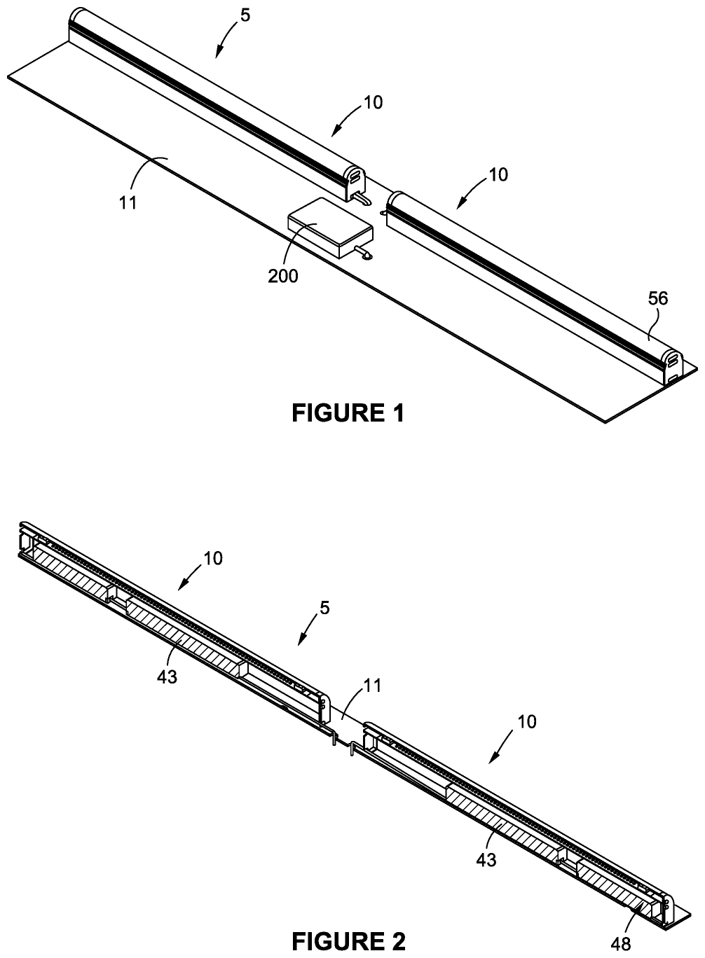

Referring now to the drawings for which the showings are for purposes of illustrating preferred embodiments of the present disclosure only, and not for purposes of limiting the same, FIGS. 1-2 depict an exemplary assembly 5 comprising two LED light bars 10 mounted to a common substrate 11 in spaced, end-to-end relation to each other, each of the LED light bars 10 being constructed in accordance with a first embodiment of the present disclosure. In a non-retrofit application, the substrate 11 is used to facilitate the attachment of the LED light bar 10 to an underlying support surface, such as a ceiling structure. As indicated above, while the assembly 5 finds particular utility in non-retrofit applications, it is contemplated that one or more LED light bars 10 standing alone (i.e., not attached to the substrate 11) may be used as part of a complete retrofit system for a variety of linear fluorescent light fixtures. In the discussion which follows, the structural and functional features of one of the two LED light bars 10 of the assembly 5 will be described with particularity, it being recognized that such description is equally applicable to the remaining one of the LED light bars 10 included in the assembly 5. Further, though the assembly 5 itself is shown as including two LED light bars 10 in an end-to-end arrangement as indicated above, those of ordinary skill in the art will recognize non-retrofit assemblies including differing numbers of LED light bars 10 mounted to the substrate 11 in potentially differing arrangements (e.g., side-by-side) are intended fall within the spirit and scope of the present disclosure.

In an exemplary embodiment of the present disclosure, the LED light bar 10 may be provided in one of several nominal lengths, e.g., about 21 inches and about 45 inches, to retrofit the most popularly installed fluorescent light fixtures. However, those of ordinary skill in the art will recognize that these length dimensions are exemplary only, and may be selectively increased or decreased without departing from the spirit and scope of the present disclosure.

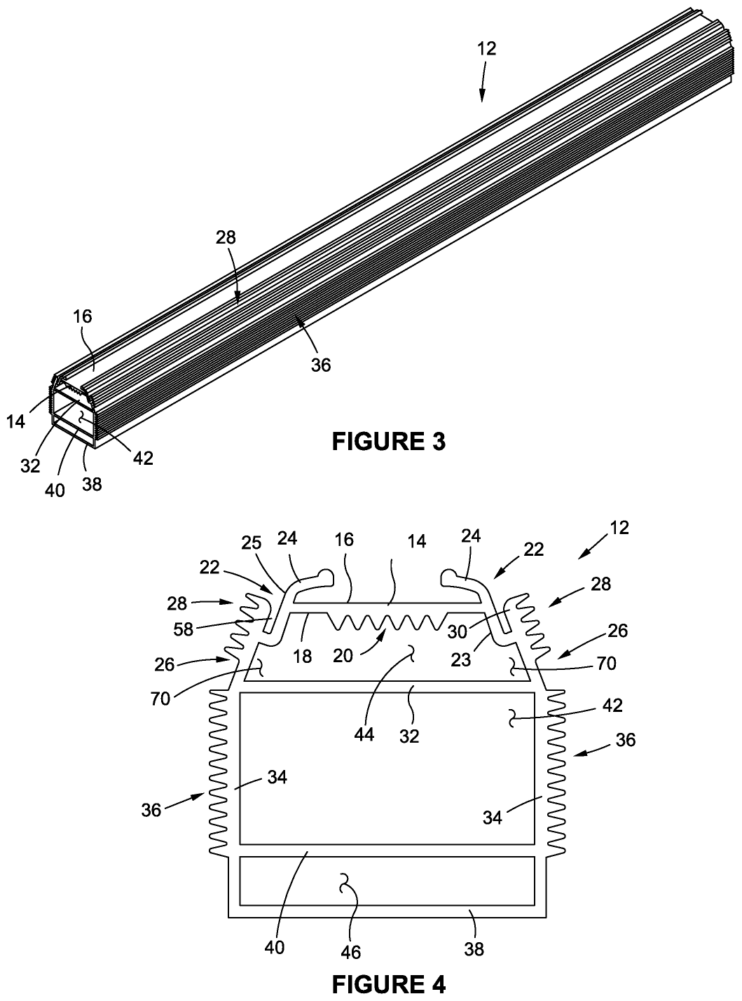

One of the primary structural features of the LED light bar 10 is an elongate channel member 12, shown with particularity in FIGS. 3-4. The channel member 12 is preferably fabricated from extruded aluminum (e.g., 6063 T5 aluminum), though other materials may be used for the fabrication of the channel member 12 without departing from the spirit and scope of the present disclosure. In greater detail, the channel member 12 comprises an elongate support portion 14 which defines opposed longitudinal sides and, from the perspective shown in FIG. 4, a generally planar first, top surface 16. In addition to the first surface 16, the support portion 14 defines a second, bottom surface 18 which extends in generally opposed relation to the first surface 16. As is most easily seen in FIG. 4, the second surface 18, in contrast to the first surface 16, does not have a generally planar configuration. Rather, a central surface region 20 of the second surface 18 has a serrated configuration, defining a multiplicity of protrusions which each have a generally triangular or wedge-shaped cross-sectional profile. As will be recognized by those of ordinary skill in the art, due to the inclusion of the central serrated surface region 20 therein, the surface area defined by the second surface 18 substantially exceeds that defined by the opposed first surface 16 in the support portion 14 of the channel member 12.

In addition to the support portion 14, the channel member 12 includes an identically configured pair along of elongate flange portions 22 which are integrally connected to and extend along respective ones of the longitudinal sides of the support portion 14 in opposed relation to each other. As further seen in FIG. 4, each of the flange portions 22 defines an elongate coupling arm segment 24 which is angularly offset relative to the remainder thereof so as to overlap or overhang a portion of the first surface of the support portion 14. The remainder of each flange portion 22 not defined by the coupling arm segment 24 extends angularly relative to the support portion 14, and defines both an interior surface 23 and an opposed exterior surface 25. The opposed longitudinal sides of the support portion 14 extend to respective ones of the interior surfaces 23. From the perspective shown in FIG. 4, that segment of each flange portion 22 which is not defined by the coupling arm segment 24 and extends below the support portion 14 is outwardly flared relative to the second surface 18. The use of the coupling arm segments 24 as defined by the flange portions 22 will be discussed in more detail below.

In addition to the support and flange portions 14, 22, the channel member 12 further comprises an identically configured pair of elongate rail portions 26 which are integrally connected to and extend along respective ones of the flange portions 22 in opposed relation to each other. As also seen in FIG. 4, each of the rail portions 26 defines an exteriorly presented serrated surface region 28 defining a multiplicity of protrusions which also each have a generally triangular or wedge-shaped cross-sectional profile. In addition to the exterior serrated surface region 28, each rail portion 26 defines an opposed interior surface 30. In the channel member 12, each flange portion 22 transitions to the interior surface 30 of a corresponding one of the rail portions 26. Similar to the support portion 14, the surface area defined by the exterior serrated surface region 28 of each rail portion 26 substantially exceeds that of the opposed interior surface 30 thereof.

When further viewed from the perspective shown in FIG. 4, in the channel member 12, the lower ends of the rail portions 26 are interconnected by a first wall portion 32 which spans the length of the channel member 12 and extends in spaced, generally parallel relation to the support portion 14. The channel member 12 further includes an opposed, identically configured pair of sidewall portions 34 which each extend at approximately a 90° angle relative to the first wall portion 32. In greater detail, each sidewall portion 34 extends from the junction where one end of the first wall portion 32 is integrally connected to the lower end of a respective one of the rail portions 26. Similar to the rail portions 26, each sidewall portion 34 defines an exteriorly presented serrated surface region 36 defining a multiplicity of protrusions which also each have a generally triangular or wedge-shaped cross-sectional profile.

In the channel member 12, as further viewed from the perspective shown in FIG. 4, the lower ends of the sidewall portions 34 are interconnected by a second wall portion 38 which extends generally perpendicularly therebetween. The second wall portion 38 also spans the length of the channel member 12, and extends in spaced, generally parallel relation to the first wall portion 32 (and hence the support portion 14). The channel member 12 further includes a third wall portion 40 which interconnects and extends generally perpendicularly between the sidewall portions 34. The third wall portion 40 also spans the length of the channel member 12, and extends in spaced, generally parallel relation to both the first and second wall portions 32, 38. As seen in FIGS. 3 and 4, the third wall portion 40 is positioned between the first and second wall portions 32, 38, though it is disposed closer to the second wall portion 38 than to the first wall portion 32.

Based on its structural features as described above, the channel member 12 includes a primary interior chamber 42 which spans the length thereof, and has a generally quadrangular (e.g., rectangular) cross-sectional configuration. The interior chamber 42 is collectively defined by the first and third wall portions 32, 40, and the sidewall portions 34. The channel member 12 also includes a first airflow cavity 44 and a second air flow cavity 46 which also each span the length thereof, the second airflow cavity 46 having a generally quadrangular (e.g., rectangular) cross-sectional configuration. The first air flow cavity 44 is collectively defined by the first wall portion 32, the support portion 14 (and in particular the second surface 18 thereof), the flange portions 22 (and in particular the interior surfaces 23 thereof), and the rail portions 26 (and in particular the interior surfaces 30 thereof). The second air flow cavity 46 is collectively defined by the second and third wall portions 38, 40, and the sidewall portions 34. The use of the interior chamber 42, and the first and second air flow cavities 44, 46, will be described in more detail below.

The LED light bar 10 further comprises an elongate LED strip 48 which is most easily seen in FIG. 6. In the LED light bar 10, the LED strip 48 preferably comprises an elongate core 50 which has a strip-like configuration and, from the perspective shown in FIG. 6, defines opposed, generally planar top and bottom surfaces. The core 50 is preferably fabricated from aluminum, though alternative materials may be used without departing from the spirit and scope of the present disclosure. Disposed on the top surface of the core 50 is a multiplicity of LEDs 52. The LEDs 52 are disposed on the top surface of the core 50 in a prescribed pattern or arrangement which, as shown in FIG. 6, comprises two side-by-side, generally parallel rows thereof. In an LED light bar 10 having a nominal length of about 21 inches, it is contemplated that the LED strip 48 thereof will be outfitted with about 144 LEDs 52. In an LED light bar 10 having a nominal length of about 45 inches it is contemplated that the LED strip 48 thereof will be outfitted with about 288 LEDs 52. However, those of ordinary skill in the art will recognize that the number and arrangement of LEDs 52 disposed on the top surface of the core 50 in the LED strip 48 integrated into the LED light bar 10 may also be varied from that described above without departing from the spirit and scope of the present disclosure.

In addition to the LEDs 52, the LED strip 48 preferably includes a plurality of metal-oxide-semiconductor field-effect transistors (MOSFETs) 54 integrated therein as modalities to help facilitate the Li-Fi functionality of the LED bar light bar 10. In the exemplary embodiment shown in FIG. 6, six MOSFETs 54 are attached to the top surface of the core 50 in a generally linear arrangement, and in side-by-side relation to the parallel rows of LEDs 52. However, those of ordinary skill in the art will recognize that the number and arrangement of MOSFETs 54 disposed on the top surface of the core 50 in the LED strip 48 integrated into the LED light bar 10 may also be varied from that described above without departing from the spirit and scope of the present disclosure.

In the LED light bar 10, it is contemplated that the LED strip 48, and in particular the core 50 thereof, may be mechanically bonded to the first surface 16 of the support portion 14 of the channel member 12. In greater detail, subsequent to the placement of the LED strip 48 upon the support portion 14 and extension of the LED strip 48 along the first surface 16 thereof, each of the coupling arm segments 24 of the flange portions 22 included in the channel member 12 will be bent slightly downwardly from the relative orientations shown in FIG. 4 so as to mechanically abut or engage the LED strip 48. Along these lines, the size and position of the LED strip 48 relative to the size and position of the coupling arm segments 24 results in the bent coupling arm segments 24 engaging corresponding portions of the top surface of the core 50 which extend along respective ones of the opposed longitudinally extending sides or edges thereof. Thus, by virtue of the abutment of the coupling arm segments 24 of the flange portions 22 against the core 50, the LED strip 48 is effectively mechanically captured between the coupling arm segments 24 and the first surface 16 of the support portion 14. It is contemplated that the length of the LED strip 48, and in particular the core 50 thereof, will be substantially equal to that of the channel member 12, thus resulting in the opposed lateral ends of the core 50 terminating in a substantially flush or continuous relationship with respective ones of the opposed lateral ends of the support portion 14, and in particular the first surface 16 thereof (and hence respective ones of the opposed lateral ends of the channel member 12). When the LED strip 48 is cooperatively engaged to the support portion 14 of the channel member 12 in the aforementioned manner, the core 50 and LEDs 52 disposed thereon are in substantial alignment or registry with the serrated central portion 20 of the second surface 18 of the support portion 14. However, those of ordinary skill in the art will recognize that alternative modalities may be employed to facilitate the engagement of the core 50 of the LED strip 48 to the first surface 16 of the support portion 14, e.g., a thermally conductive adhesive.

It is contemplated that a slight structural variant of the channel member 12 may be integrated into the LED light bar 10. In greater detail, the sole distinction between the such variant and the channel members 12 lies in the support portion 14 of the variant being provided with an identically configured pair of elongate alignment ribs formed on and extending longitudinally along the first surface 16 of the support portion 14 in spaced, generally parallel relation to each other. In this variant of the channel member 12, the alignment ribs are operative to maintain the LED strip 48 in a prescribed position on the first surface 14, thus assisting in the prevention of any undesirable movement or shifting of the LED strip 48 during the process of bending the coupling arm segments 24 of the flange portions 22 to effectively engage the same.

The LED light bar 10 may further comprise an integral volumetric diffuser 56 which is coupled to the channel member 12 and effectively covers or shields the LED strip 48. As seen in FIG. 1, the diffuser 56 has an arcuate, arch-like configuration, and is sized to span the length of the channel member 12, with the opposed lateral ends of the diffuser 48 terminating in a substantially flush or continuous relationship with respective ones of the opposed lateral ends of the channel member 12. The cooperative engagement of the diffuser 56 to the channel member 12 is preferably facilitated by the advancement of the opposed longitudinally extending edge portions of the diffuser 48 into respective ones of a complementary pair of recesses 58 defined by the channel member 12. The inclusion of the diffuser 56 in the LED light bar 10 is optional.

If the diffuser 56 is eliminated, it is contemplated that the corresponding recesses 58 could be likewise eliminate from the channel member 12.

As is best seen in FIG. 4, each recess 58 of the channel member 12 is collectively defined by the exterior surface 25 of a corresponding flange portion 22, and an opposed segment of the interior surface 30 of the corresponding rail portion 26. The diffuser 56 is frictionally retained within the recesses 58. Such frictional retention may be attributable, in part, to an outward biasing force exerted by the diffuser 56 against the channel member 12, the diffuser 56 preferably having some measure of resiliency as allows the opposed longitudinally extending edge portions thereof to be slightly flexed toward each other as allows for their advancement into respective ones of the recesses 58. An exemplary diffuser 56 integrated into the LED light bar 10 is adapted to eliminate glare and evenly distribute light, transmitting about 95% of the generated lumens from the LED strip 48. In addition, the diffuser 56 is preferably configured such that the beam angle generated by the LED light bar 10 is about 180° for wide distribution of light, which assists in facilitating the efficacy of the Li-Fi wireless communications aspects of the LED light bar 10.

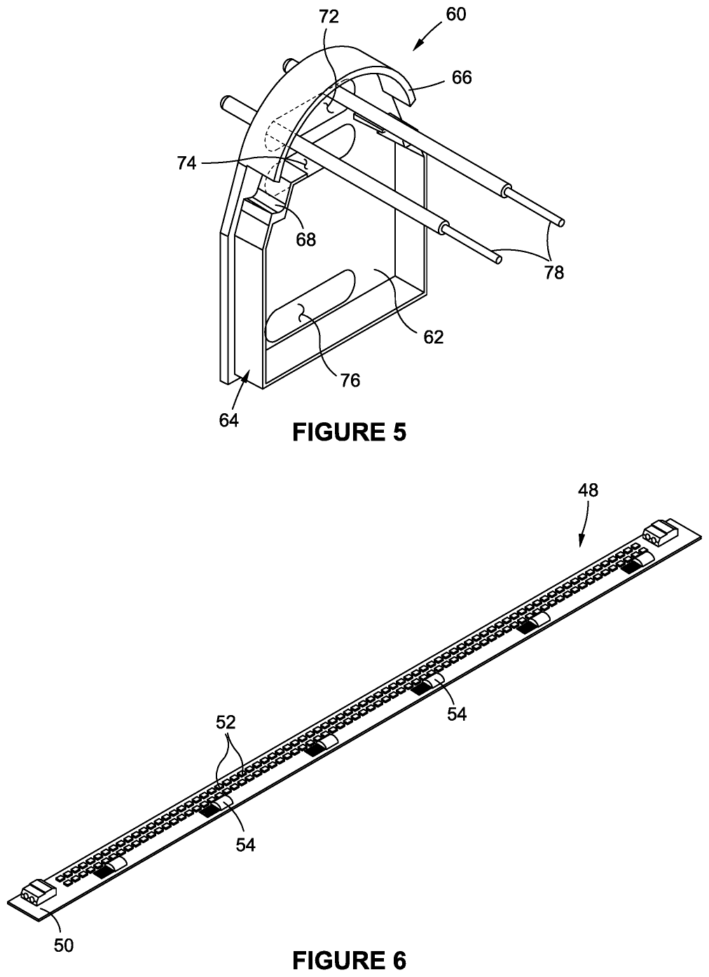

The LED light bar 10 further comprises an identically configured pairs of end caps 60 which are cooperatively engaged to respective ones of the opposed lateral ends of the channel member 12. One such end cap 60 is shown in FIG. 5 and described with particularly below, such description being equally applicable to the remaining end cap 60. Generally speaking, each of the end caps 60 comprises an end wall portion 62 having a base portion 64 integrally formed on and extending along three peripheral side segments thereof, and an arcuate flange portion 66 integrally formed on and extending along another peripheral side segment thereof in spaced relation to the base portion 64, the base and flange portions 64, 66 extending in the same direction from a common surface of the end wall portion 62. The base portion 64 protruding from the end wall portion 62 defines an opposed, identically configured pair of engagement tabs 68.

In the LED light bar 10, the engagement tabs 68 of each end cap 60 are sized and configured to be advanced into and frictionally maintained within respective ones of an opposed pair of recesses 70 which are also defined by the channel member 12. As seen in FIG. 4, each recess 70 is collectively defined by the interior surface 30 of the corresponding rail portion 26, a segment of the interior surface 23 of the corresponding flange portion 22, and the first wall portion 32. The advancement of the engagement tabs 68 into the complimentary recesses 70 is limited by the abutment of the corresponding lateral end of the channel member 12 against the end wall portion 62 of the corresponding end cap 60. As the advancement of the engagement tabs 68 of each end cap 60 into the recesses 70 occurs, the arcuate flange portion 66 of such end cap 60 is simultaneously advanced over a corresponding lateral end portion of the diffuser 56 which is preferably engaged to the channel member 12 prior to the attachment of the end caps 60 to each of the opposed ends thereof.

When cooperatively engaging each of the end caps 60 to the channel member 12 in the LED light bar 10, it will be recognized that while the engagement tabs 68 (and hence part of the base portion 64) are advanced into the recesses 70 (and hence the first air flow cavity 44), other parts of the base portion 64 are advanced into respective ones of the second air flow cavity 46 and the interior chamber 42. Along these lines, though not shown in FIG. 5 but when viewed from the perspective therein, it is contemplated that the base portion 64 will include several pairs of notches or cut-outs formed therein as allows opposed, vertically extending segments of the base portion 64 to be advanced into the interior chamber 42, and further allows opposed, vertically extending segments of the base portion 64 along with the horizontally extending segment thereof extending between and interconnecting the vertically extending segments to be advanced into the second air flow cavity 46.

Each end cap 60 further defines a first opening 72, a second opening 74 and a third opening 76 within the end wall portion 62 thereof. When the end caps 60 are cooperatively engaged to the channel member 12, each first opening 72 is aligned and fluidly communicates with the first air flow cavity 44 of the channel member 12. Each first opening 72 is further aligned and fluidly communicates with a cavity of the LED light bar 10 which is collectively defined by portions of the channel member 12, and both the LED strip 48 and diffuser 56 attached to the channel member 12. Each second opening 74 is aligned and fluidly communicates with the interior chamber 42 of the channel member 12. Each third opening 76 is aligned and fluidly communicates with the second air flow cavity 46 of the channel member 12.

The exemplary end cap 60 shown in FIG. 5 is further outfitted with structural features particularly suited for use of the LED light bar(s) 10 in a retrofit application. These structures are a spaced, generally parallel pair of leads 78 which are secured to the end wall portion 62 and protrude perpendicularly from each of the opposed sided thereof. These leads 78, if included in the end caps 60, may be used to facilitate the retrofit attachment of the LED light bar 10 to a socket (e.g., tombstone) of an existing fixture adapted to accommodate a fluorescent tube. However, those of ordinary skill in the art will recognize that in non-retrofit application, such as where the LED light bar(s) 10 are attached to the substrate 11, the leads 78 may be omitted from the end caps 60.

The serrated surface regions 20, 28, 36 of the channel member 12 of the LED light bar 10 provide superior heat dissipation, thus allowing the channel member 12 to effectively function as a heat sink for the LED strip 48, and to other components 43 which may be accommodated within the interior chamber 42 defined thereby. In this regard, the interior chamber 42 is typically used to accommodate a power supply/driver and/or other hardware (e.g., a router or switch) necessary to impart Li-Fi wireless communications transmission capability to the LEDs 52 of the LED strip 48.

In greater detail, during operation of the LED light bar 10, the heat generated by the activation of the LEDs 52 is effectively transferred to the core 50 of the LED strip 48. As a result of its direct contact with the first surface 16 of the support portion 14, the core 50 (which is also fabricated from aluminum as indicated above) in turn transfers the heat to the support portion 14 of the channel number 12. Heat transferred from the core 50 to the support portion 14 is in turn effectively dissipated into air within the first air flow cavity 44, the heat transfer from the support portion 14 to the first air flow cavity 44 being enhanced by the inclusion of the serrated central region 20 of the second surface 18 which allows the support portion 14 to more effectively function as a heat sink. Heat transferred to the support portion 14 from the core 50 is further transferred to the rail portions 26 via respective ones of the intervening flange portions 22 which, as indicated above, are integrally connected to both the support portion 14 and the rail portions 26. Heat transferred to the rail portions 26 is effectively dissipated to ambient air by the serrated regions 28 thereof. Thus, the support portion 14 (attributable to its inclusion of the serrated surface region 20) and the rail portions 26 (attributable to their inclusion of the serrated regions 28) effectively define three (3) separate heat sinks within the channel member 12 which allow for the efficient, effective dissipation of heat generated by the LEDs 52 of the LED strip 48. In addition, natural air circulation through the first air flow cavity 44 as afforded by the openings 72 within the end caps 60 assists in the dissipation of heat from the LED light bar 10.

In addition, during operation of the LED light bar 10, the heat generated by the activation of any components 43 disposed within the interior chamber 42 is effectively transferred into the first and third wall portions 32, 40, and sidewall portions 34, of the channel member 12. Heat transferred into the first and third wall portions 32, 40 is in turn effectively dissipated into air within the first and second air flow cavities 44, 46. The dissipation of heat transferred into the sidewall portions 34 is enhanced by the inclusion of the serrated surface regions 36 thereof which allow the sidewall portions 34 to more effectively function as heat sinks. In this regard, heat transferred to the sidewall portions 34 is effectively dissipated to ambient air by the serrated regions 36 thereof. In addition, natural air circulation through the first air flow cavity 44 as afforded by the openings 72 within the end caps 60, through the second air flow cavity 46 as afforded by the openings 76 within the end caps 60, and further through the interior chamber 42 as afforded by the openings 74 within the end caps 60, assists in the dissipation of heat from any components 43 within the interior chamber 42. Thus, in the LED light bar 10, the first air flow cavity 44 under the LED strip 48 allows for the effective dissipation of heat during operation of the LED light bar 10. In addition, the size and placement of the first and second air flow cavities 44, 46 relative to the interior chamber 42 allows for the effective dissipation of heat from any components 43 housed within the interior chamber 42 during operation of the LED light bar 10. The preferred mechanical bonding of the LED strip 48 to the channel member 12, and placement of other components 43 into the interior chamber 42, maximizes the efficacy or functionality of the channel member as a heat sink.

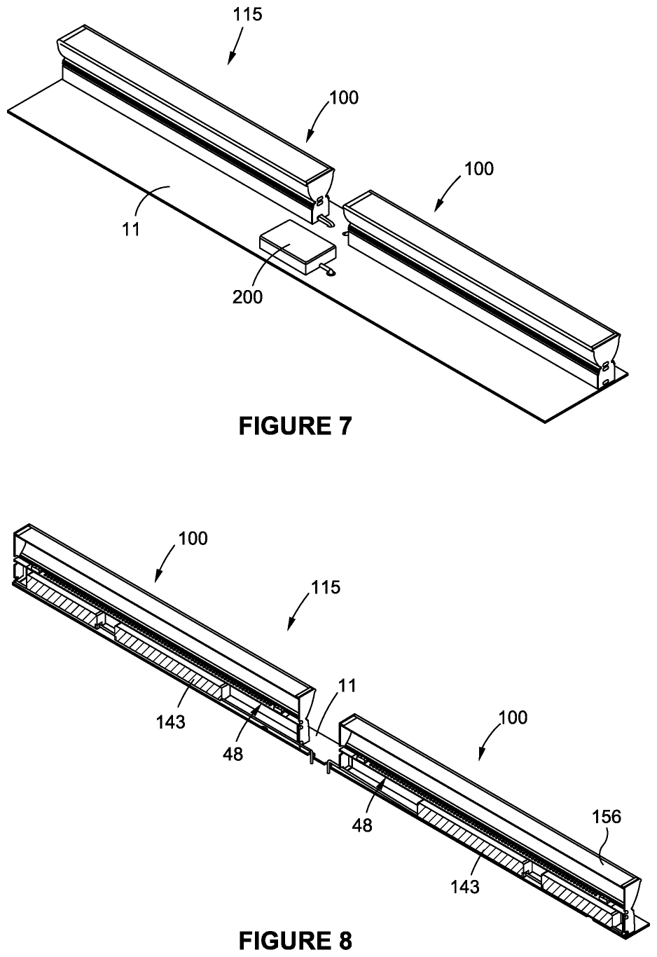

Referring now to FIGS. 7-8, there is shown an exemplary assembly 115 comprising two LED light fixtures 100 mounted to the common substrate 11 in spaced, end-to-end relation to each other, each of the LED light fixtures 100 being constructed in accordance with a second embodiment of the present disclosure. In a non-retrofit application, the substrate 11 is used to facilitate the attachment of the LED light fixtures 100 to an underlying support surface, such as a ceiling structure. As indicated above with respect to the assembly 5, while the assembly 115 finds particular utility in non-retrofit applications, it is contemplated that one or more LED light fixtures 100 standing alone (i.e., not attached to the substrate 11) may be used as part of a complete retrofit system for a variety of linear fluorescent light fixtures. In the discussion which follows, the structural and functional features of one of the two LED light fixtures 100 of the assembly 115 will be described with particularity, it being recognized that such description is equally applicable to the remaining one of the LED light fixtures 100 included in the assembly 115. Further, though the assembly 115 itself is shown as including two LED light fixtures 100 in an end-to-end arrangement as indicated above, those of ordinary skill in the art will recognize non-retrofit assemblies including differing numbers of LED light fixtures 100 mounted to the substrate 11 in potentially differing arrangements (e.g., side-by-side) are intended fall within the spirit and scope of the present disclosure. The LED high bay light fixture 100 of the second embodiment is particularly suited for use in applications wherein it is separated from the ground by a distance of about 10 feet up to about twenty (20) feet or more.

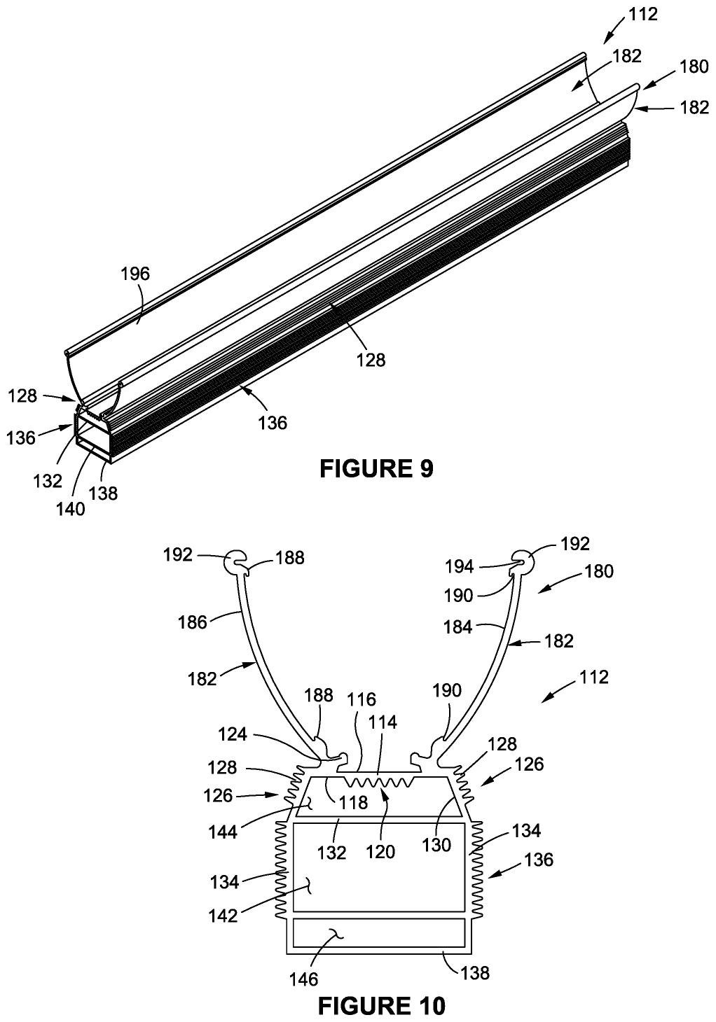

One of the primary structural features of the LED light fixture 100 is an elongate channel member 112, shown with particularity in FIGS. 9-10. The channel member 112 is preferably fabricated from extruded aluminum (e.g., 6063 T5 aluminum), though other materials may be used for the fabrication of the channel member 112 without departing from the spirit and scope of the present disclosure. In greater detail, the channel member 112 comprises an elongate support portion 114 which defines opposed longitudinal sides and, from the perspective shown in FIGS. 9 and 10, a generally planar first, top surface 116. In addition to the first surface 116, the support portion 114 defines a second, bottom surface 118 which extends in generally opposed relation to the first surface 116. As is most easily seen in FIG. 10, the second surface 118, in contrast to the first surface 116, does not have a generally planar configuration. Rather, a central region 120 of the second surface 118 has a serrated configuration, defining a multiplicity of protrusions which each have a generally triangular or wedge-shaped cross-sectional profile. As will be recognized by those of ordinary skill in the art, due to the inclusion of the serrated central region 120 therein, the surface area defined by the second surface 118 substantially exceeds that defined by the opposed first surface 116 in the support portion 114 of the channel member 112.

In addition to the support portion 114, the channel member 112 includes an identically configured pair along of elongate coupling arm segments 124 which protrude angularly toward each other from the first surface 116 of the support portion 114 so as to overlap or overhang a portion of the first surface 116. The use of the coupling arm segments 124 will be discussed in more detail below.

In addition to the coupling arm segments 124, the channel member 112 comprises an identically configured pair of elongate rail portions 126 which are integrally connected to and extend along respective ones of the longitudinal sides of the support portion 114 in opposed relation to each other. From the perspective shown in FIGS. 9 and 10, each rail portion 126 extends below the support portion 114 and is outwardly flared relative to the second surface 118. Each of the rail portions 126 defines an exteriorly presented serrated surface region 128 defining a multiplicity of protrusions which also each have a generally triangular or wedge-shaped cross-sectional profile. In addition to the exterior serrated surface region 128, each rail portion 126 defines an opposed interior surface 130, the opposed longitudinal sides of the support portion 114 extending to respective ones of the interior surfaces 130. Similar to the support portion 114, the surface area defined by the exterior serrated surface region 128 of each rail portion 126 substantially exceeds that of the opposed interior surface 130 thereof.

When further viewed from the perspective shown in FIG. 10, in the channel member 112, the lower ends of the rail portions 126 are interconnected by a first wall portion 132 which spans the length of the channel member 112 and extends in spaced, generally parallel relation to the support portion 114. The channel member 112 further includes an opposed, identically configured pair of sidewall portions 134 which each extend at approximately a 90° angle relative to the first wall portion 132. In greater detail, each sidewall portion 134 extends from the junction where one end of the first wall portion 132 is integrally connected to the lower end of a respective one of the rail portions 126. Similar to the rail portions 126, each sidewall portion 134 defines an exteriorly presented serrated surface region 136 defining a multiplicity of protrusions which also each have a generally triangular or wedge-shaped cross-sectional profile.

In the channel member 112, as further viewed from the perspective shown in FIG. 10, the lower ends of the sidewall portions 134 are interconnected by a second wall portion 138 which extends generally perpendicularly therebetween. The second wall portion 138 also spans the length of the channel member 112, and extends in spaced, generally parallel relation to the first wall portion 132 (and hence the support portion 114). The channel member 112 further includes a third wall portion 140 which interconnects and extends generally perpendicularly between the sidewall portions 134. The third wall portion 140 also spans the length of the channel member 112, and extends in spaced, generally parallel relation to both the first and second wall portions 132, 138. As seen in FIGS. 9 and 10, the third wall portion 140 is positioned between the first and second wall portions 132, 138, though it is disposed closer to the second wall portion 138 than to the first wall portion 132.

Based on its structural features as described above, the channel member 112 includes a primary interior chamber 142 which spans the length thereof, and has a generally quadrangular (e.g., rectangular) cross-sectional configuration. The interior chamber 142 is collectively defined by the first and third wall portions 132, 140, and the sidewall portions 134. The channel member 112 also includes a first airflow cavity 144 and a second air flow cavity 146 which also each span the length thereof, the second airflow cavity 146 having a generally quadrangular (e.g., rectangular) cross-sectional configuration. The first air flow cavity 144 is collectively defined by the first wall portion 132, the support portion 114 (and in particular the bottom surface 118 thereof), and the rail portions 126 (and in particular the interior surfaces 130 thereof). The second air flow cavity 146 is collectively defined by the second and third wall portions 138, 140, and the sidewall portions 134. The use of the interior chamber 142, and the first and second air flow cavities 144, 146, will be described in more detail below.

The channel member 112 further comprises a generally parabolic reflector portion 180. As seen in FIGS. 9 and 10, the reflector portion 180 comprises an identically configured pair of arcuate side sections 182, each of which defines a generally concave interior surface 184 and a generally convex exterior surface 186. The side sections are 182 integrally connected to the to the support portion 114 so as to protrude from the first surface 116 in spaced, opposed relation to each other. In the channel member 112, each the coupling arm segments 124 is proximate and extends inwardly relative to the interior surface 184 of a respective one of the side sections 182.

In the reflector portion 180, the interior surface 184 of each of the side sections 182 includes a pair retentions tabs 188 protruding therefrom in spaced relation to each other. The retention tabs 188 of each pair are integrally connected to the remainder of the corresponding side section 182, with one of these retention tabs 188 being disposed proximate and extending along the length of the distal edge of the corresponding side section 182, and the remaining retention tab 188 of the same pair being disposed proximate and extending along the length of a respective one of the coupling arm segments 124. Each retention tab 188 and a portion of the interior surface 184 of the corresponding side section 182 collectively define an elongate retention slot 190, with the retention slots 190 of each pair defined by one of the side sections 182 facing each other. The use of the retention slots 190 will be described in more detail below.

Each side section 182 of the reflector portion 180 further includes an attachment hub 192 integrally connected to an extending along the length of the distal edge thereof. The attachment hubs 192 each have a generally circular cross-sectional configuration, and extend in spaced, generally parallel relation to each other in the manner best shown in FIG. 10. In addition, each of the attachment hubs 192 defines an elongate attachment slot 194 which extends along the length thereof, the attachment slots 194 being proximate respective ones of the distal-most retention tabs 188 of the corresponding pair, and facing inwardly toward each other in the manner also shown in FIG. 10. The use of the attachments slots 194 will be described in more detail below.

As shown in FIG. 8, the LED light fixture 100 further comprises the same elongate LED strip 48 described above in relation to the LED light bar 10, the structural particulars of such LED strip being set forth above and not repeated here.

In the LED light fixture 100, it is contemplated that the LED strip 48, and in particular the core 50 thereof, may be mechanically bonded to the first surface 116 of the support portion 114 of the channel member 112. In greater detail, subsequent to the placement of the LED strip 48 upon the support portion 114 and extension of the LED strip 48 along the first surface 116 thereof, each of the coupling arm segments 124 of the channel member 112 will be bent slightly downwardly from the relative orientations shown in FIG. 10 so as to mechanically abut or engage the LED strip 48. In greater detail, the size and position of the LED strip 48 relative to the size and position of the coupling arm segments 124 results in the bent coupling arm segments 124 engaging corresponding portions of the first surface of the core 50 which extend along respective ones of the opposed longitudinally extending sides or edges thereof. Thus, by virtue of the abutment of the coupling arm segments 124 against the core 50, the LED strip 48 is effectively mechanically captured between the coupling arm segments 124 and the first surface 116 of the support portion 114. It is contemplated that the length of the LED strip 48, and in particular the core 50 thereof, will be substantially equal to that of the channel member 112, thus resulting in the opposed lateral ends of the core 50 terminating in a substantially flush or continuous relationship with respective ones of the opposed lateral ends of the support portion 114, and in particular the first surface 116 thereof (and hence respective ones of the opposed lateral ends of the channel member 112). When the LED strip 140 is cooperatively engaged to the support portion 114 of the channel member 112 in the aforementioned manner, the core 50 and LEDs 52 disposed thereon are in substantial alignment or registry with the serrated central surface region 120 of the second surface 118 of the support portion 114. Again, those of ordinary skill in the art will recognize that alternative modalities may be employed to facilitate the engagement of the core 50 of the LED strip 48 to the first surface 116 of the support portion 114, e.g., a thermally conductive adhesive.

Though not shown, it is contemplated that a variant of the channel member 112 may be provided which is analogous the variant of the channel member 12 described above. In this regard, the support portion 114 of the channel member 112 may be provided with the above-described identically configured pair of elongate alignment ribs formed on and extending longitudinally along the first surface 116 in spaced, generally parallel relation to each other. These alignment ribs, if included in the channel member 112, would be operative to maintain the LED strip 48 in a prescribed position on the first surface 114, thus assisting in the prevention of any undesirable movement or shifting of the LED strip 48 during the process of bending the coupling arm segments 124 to effectively engage the same.

The LED high bay light fixture 100 further preferably comprises an identically configured pair of elongate, generally planar and sheet-like or film-like reflective inserts 196 which are integrated into the reflector portion 180. In greater detail, each of the inserts 196 is sufficiently pliable and sized such that when slightly bent to assume an arcuate profile, portions of each insert 196 extending along each of the opposed longitudinal edges thereof may be slidably advanced into the retention slots 190 of a corresponding pair defined by a respective one of the side sections 182. Thus, when fully advanced into the retention slots 190 defined by a corresponding pair of the retention tabs 188, each of the inserts 196 extends along and covers the majority of the area of the concave interior surface 184 defined by a respective one of the side sections 182. Each insert 196 is preferably fabricated from a material providing ultra-high reflectivity, and preferably one which reflects about 98% of the light applied thereto. However, the inserts 196 are optional, and need not be included with the reflector portion 180. If the inserts 196 are eliminated, it is contemplated that the corresponding retentions slots 190 could be likewise eliminate from the channel member 112. It is also contemplated that in lieu of using the inserts 196, the interior surfaces 184 of the side sections 182 may be polished in a manner which optimizes or maximizes the reflective properties of the reflector portion 180.

The structural features/contours of the reflector portion 180, and in particular the side sections 182 thereof are, in concert with the properties of the inserts 196 applied thereto, designed to optimize the amount and consistency of distribution of the light emitted from the LED light fixture 100. In an exemplary embodiment, the light distribution optimization properties of the reflector portion 180 are a function of the specific dimensional parameters/relationships. The objective of the design of the reflector portion 180 is to get as much light as possible as generated by the activation of the LED strip 48 directed from the reflector portion 180, based on contemplated mounting heights of the LED light fixture 100 starting at about twenty feet. As will be recognized, in the context of Li-Fi wireless communications, the transmission optimization facilitated by the reflector portion 180 is a key attribute of ensuring the efficacy, efficiency, and reliability of such communications. Along these lines, the distance the side sections 182 are separated from each other, the parabolic shape of the reflector portion 180 collectively defined by the arcuate profiles of the side sections 182, the rate at which the side sections 182 get farther apart as they extend away from the support portion 114, and how far the side sections 182 extend away from the support portion 114 are all optimized to achieve such objective. In the LED light fixture 100, the light emitted from the LEDs 52 of the LED strip 48 is both projected directly from the reflector portion 180 and reflected off the inserts 196 extending along the interior surfaces 184 of the side sections 182 of the reflector portion 180. The curvature of the side sections 182 is optimized to get light out of the reflector portion 180 after only one bounce off of either insert 196, as opposed to reflecting from one side section 182 to the other side section 182, as each bounce of light decreases the light that is able to reach the work surface.

As seen in FIG. 8, it is completed that the LED light fixture 100 may further be outfitted with an elongate, generally planar and sheet-like diffuser 156 which is also integrated into the reflector portion 180. In greater detail, portions of the diffuser 156 extending along each of the opposed longitudinal edges thereof may be slidably advanced into respective ones of the attachments slots 194 defined by the attachments hubs side sections 192. When fully advanced into the attachments slots 194, the diffuser 156 essentially encloses the interior of the reflector portion 180, all of the light emitted from the LEDs 52 thus passing through the diffuser 156. An exemplary diffuser 156 integrated into the LED light fixture 100 is adapted to eliminate glare and evenly distribute light, transmitting about 95% of the generated lumens from the LED strip 48.

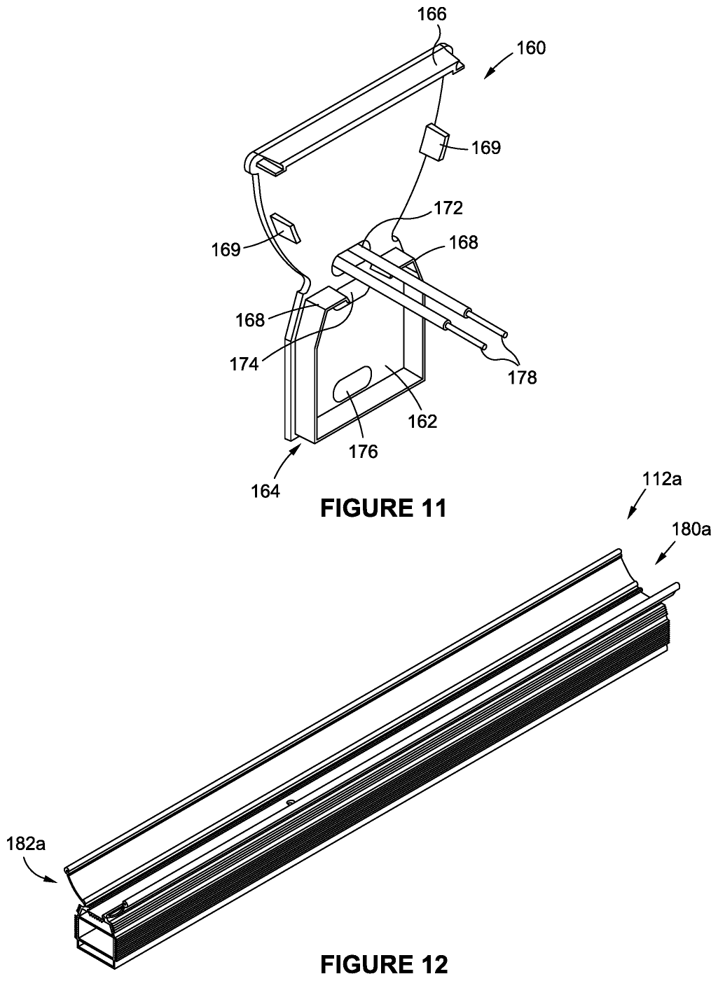

Referring now to FIG. 11, the LED light fixture 100 further comprises an identically configured pairs of end caps 160 which are cooperatively engaged to respective ones of the opposed lateral ends of the channel member 112. Generally speaking, each of the end caps 160 comprises an end wall portion 162 having a base portion 164 integrally formed on and extending along three peripheral side segments thereof, and a flange portion 166 integrally formed on and extending along another peripheral side segment thereof, the base and flange portions 164, 166 extending in the same direction from a common surface of the end wall portion 162. The base portion 164 protruding from the end wall portion 162 defines an opposed, identically configured pair of engagement tabs 168. Another pair of engagement tabs 169 is formed on the end wall portion 162 in spaced relation to each other and proximate respective ones of opposed peripheral side segments defined by the end wall portion 169, these engagement tabs 169 also extending in the same direction as the flange portion 166 and base portion 164.

In the LED light fixture 100, the engagement tabs 168 of each end cap 160 are sized and configured to be advanced into and frictionally maintained within the first air flow cavity 144 of the channel member 112. In greater detail, when advanced into the first air flow cavity 144, the engagement tabs 168 abut and are cooperatively engaged to the interior surfaces 130 of the rail portions 126, and the bottom, second surface 118 of the support portion 114. The advancement of the engagement tabs 168 into the first air flow cavity 144 is limited by the abutment of the corresponding lateral end of the channel member 112 against the end wall portion 162 of the corresponding end cap 160. As the advancement of the engagement tabs 168 of each end cap 160 into the first air flow cavity 144 occurs, the opposed lateral end portions of the flange portion 166 of such end cap 160 are simultaneously advanced into respective ones of the attachments slots 194 defined by the attachment hubs 192, the size and shape of the end portions being complimentary to that of the attachments slots 194 as allows the end portions to be frictionally maintained therein. Also, at the same time, the engagement tabs 169 of such end cap 160 are advanced into one open end of the reflector portion 180, and frictionally seated against respective ones of the inserts 196 applied to the interior surface 184 of respective ones of the side sections 182.

When cooperatively engaging each of the end caps 160 to the channel member 112 in the LED light fixture 100, it will be recognized that while the engagement tabs 168 (and hence part of the base portion 164) are advanced into the first air flow cavity, other parts of the base portion 164 are advanced into respective ones of the second air flow cavity 146 and the interior chamber 142. Along these lines, though not shown in FIG. 11 but when viewed from the perspective therein, it is contemplated that the base portion 164 will include several pairs of notches or cut-outs formed therein as allows opposed, vertically extending segments of the base portion 164 to be advanced into the interior chamber 2, and further allows opposed, vertically extending segments of the base portion 164 along with the horizontally extending segment thereof extending between and interconnecting the vertically extending segments to be advanced into the second air flow cavity 146.

Each end cap 160 further defines a first opening 172, a second opening 174 and a third opening 176 within the end wall portion 162 thereof. When the end caps 160 are cooperatively engaged to the channel member 112, each first opening 172 is aligned and fluidly communicates with the first air flow cavity 144 of the channel member 112. Each first opening 172 is further aligned and fluidly communicates with the interior of the reflector portion 180. Each second opening 174 is aligned and fluidly communicates with the interior chamber 142 of the channel member 112. Each third opening 176 is aligned and fluidly communicates with the second air flow cavity 146 of the channel member 112.

The exemplary end cap 160 shown in FIG. 11 is further outfitted with structural features particularly suited for use of the LED light fixture(s) 100 in a retrofit application. These structures are a spaced, generally parallel pair of leads 178 which are secured to the end wall portion 162 and protrude perpendicularly from each of the opposed sided thereof. These leads 178, if included in the end caps 160, may be used to facilitate the retrofit attachment of the LED light fixture 100 to a socket (e.g., tombstone) of an existing fixture adapted to accommodate a fluorescent tube. However, those of ordinary skill in the art will recognize that in non-retrofit application, such as where the LED light fixture(s) 100 are attached to the substrate 11, the leads 178 may be omitted from the end caps 160.

The serrated surface regions 120, 128, 136 of the channel member 112 of the LED light fixture 100 provide superior heat dissipation, thus allowing the channel member 112 to effectively function as a heat sink for the LED strip 48, and to other components 143 (as shown in FIG. 8) which may be accommodated within the interior chamber 142 defined thereby. In this regard, the interior chamber 142 is typically used to accommodate a power supply/driver and/or other hardware (e.g., a router or switch) necessary to impart Li-Fi wireless communications transmission capability to the LEDs 52 of the LED strip 48.

In greater detail, during operation of the LED light fixture 100, the heat generated by the activation of the LEDs 52 is effectively transferred to the core 50 of the LED strip 48. As a result of its direct contact with the first surface 116 of the support portion 114, the core 50 (which is also fabricated from aluminum as indicated above) in turn transfers the heat to the support portion 114 of the channel number 112. Heat transferred from the core 50 to the support portion 114 is in turn effectively dissipated into air within the first air flow cavity 144, the heat transfer from the support portion 114 to the first air flow cavity 144 being enhanced by the inclusion of the serrated central surface region 120 of the second surface 118 which allows the support portion 114 to more effectively function as a heat sink. Heat transferred to the support portion 114 from the core 50 is further transferred to the rail portions 126. Heat transferred to the rail portions 126 is effectively dissipated to ambient air by the serrated surface regions 128 thereof. Thus, the support portion 114 (attributable to its inclusion of the serrated surface region 120) and the rail portions 126 (attributable to their inclusion of the serrated surface regions 128) effectively define three (3) separate heat sinks within the channel member 112 which allow for the efficient, effective dissipation of heat generated by the LEDs 52 of the LED strip 48. In addition, natural air circulation through the first air flow cavity 144 and the interior area of the reflector portion 180 as afforded by the first openings 172 within the end caps 160 assists in the dissipation of heat from the LED light fixture 100.

In addition, during operation of the LED light fixture 100, the heat generated by the activation of any components 143 disposed within the interior chamber 142 is effectively transferred into the first and third wall portions 132, 140, and sidewall portions 134, of the channel member 112. Heat transferred into the first and third wall portions 132, 140 is in turn effectively dissipated into air within the first and second air flow cavities 144, 146. The dissipation of heat transferred into the sidewall portions 134 is enhanced by the inclusion of the serrated surface regions 136 thereof which allow the sidewall portions 134 to more effectively function as heat sinks. In this regard, heat transferred to the sidewall portions 134 is effectively dissipated to ambient air by the serrated surface regions 136 thereof. In addition, natural air circulation through the first air flow cavity 144 as afforded by the first openings 172 within the end caps 160, through the second air flow cavity 146 as afforded by the second openings 176 within the end caps 160, and further through the interior chamber 42 as afforded by the third openings 174 within the end caps 160, assists in the dissipation of heat from any components 143 1 within the interior chamber 142. Thus, in the LED light fixture 100, the first air flow cavity 144 under the LED strip 48 allows for the effective dissipation of heat during operation of the LED light fixture 100. In addition, the size and placement of the first and second air flow cavities 144, 146 relative to the interior chamber 142 allows for the effective dissipation of heat from any components 143 housed within the interior chamber 142 during operation of the LED light fixture 110. The preferred mechanical bonding of the LED strip 48 to the channel member 112, and placement of other components 143 into the interior chamber 142, maximizes the efficacy or functionality of the channel member 112 as a heat sink.

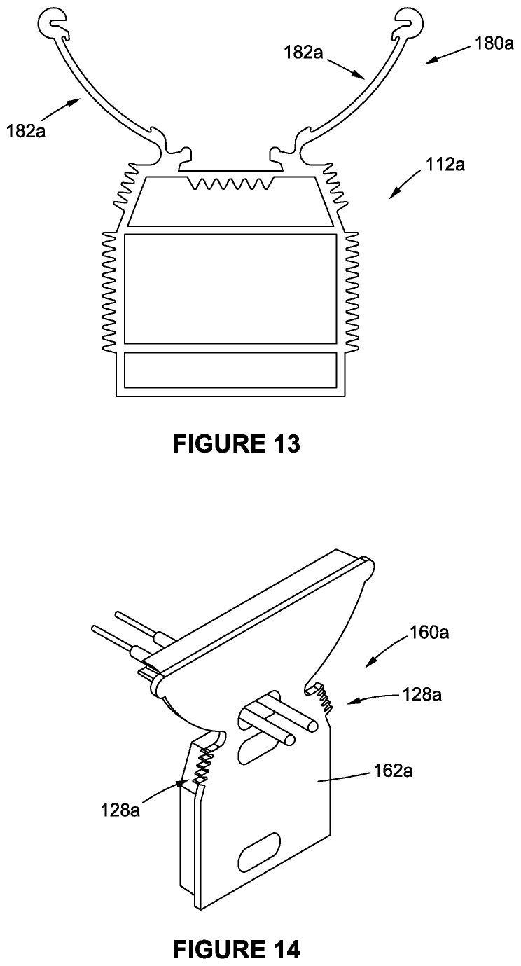

Referring now to FIGS. 12-13, it is contemplated that a channel member 112a may be used in substitution for the channel member 112 in a variant of the LED light fixture 100. The channel member 112a is identical to the channel member 112 as described in detail above in all respects, with the exception that the reflector portion 180a of the channel member 112a is comparatively small, attributable to the shorter profiles of the side sections 182a thereof. smaller channel member 112 may be provided which is analogous the variant of the channel member 12 described above. Whereas the objective of the design of the reflector portion 180 is to get as much light as possible as generated by the activation of the LED strip 48 directed from the reflector portion 180 based on contemplated mounting heights of the LED light fixture 100 starting at about twenty feet, the objective of the design of the reflector portion 180a is to get as much light as possible as generated by the activation of the LED strip 48 directed from the reflector portion 180a based on contemplated mounting heights of the LED light fixture 100 starting at about ten feet.

Referring now to FIG. 14, there is shown an exemplary end cap 160a which may be used in conjunction with the channel member 112a in substitution for the end cap 160. The end cap 160a is identical to the end cap 160 as described in detail above in all respects, with the exceptions being that the end wall portion 162a is provided in size which is commensurate with that of the reflector portion 180a, and is further outfitted with an opposed pair of serrated peripheral surface regions 128a which essentially mirror the serrated surface regions 128 of the rail portions 126 when the end caps 160a are attached to respective ones of the opposed ends of the channel member 112a. Again, in the context of Li-Fi wireless communications, the transmission optimization facilitated by the reflector portion 180a at lower ceiling heights is a key attribute of ensuring the efficacy, efficiency, and reliability of such communications.

In either of the assemblies 5, 115, it is contemplated that the substrate 11 may include a Li-Fi related component such as an access point (AP) box 200 mounted thereto proximate to the LED light bar(s) 10 or LED light fixture(s) 100. However, the arrangement of the AP box 200 relative to remaining parts of each assembly 5, 115 as shown in FIGS. 1 and 7 is exemplary only, and may be modified without departing from the spirit and scope of the present disclosure. As indicated above, that rather than being attached to the substrate 11 in a non-retrofit application, one or more LED light bars 10 or light fixtures 100 may be retrofit the housing of an existing fluorescent fixture.

This disclosure provides exemplary embodiments of the present disclosure. The scope of the present disclosure is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. An LED light fixture, comprising:
an elongate channel member defining:
an elongate support portion which defines a first surface and an opposed second surface, at least a portion of the second surface having a serrated configuration of increased surface area;
a pair of rail portions integrally connected to the support portion and each defining an exteriorly presented surface which includes a serrated surface region;
an opposed pair of sidewall portions integrally connected to respective ones of the rail portions, each defining an exteriorly presented surface which includes a serrated surface region;
at least first and second wall portions integrally connected and extending between the sidewall portions in a manner facilitating the formation of an interior chamber, and at least a first air flow cavity extending between the support portion and the interior chamber; and
a generally parabolic reflector portion which protrudes from the first surface of the support portion;
an LED strip attached to and the channel member and extending along at least portion of the first surface of support portion thereof, the LED strip being maintained in engagement to the support portion.

2. The LED light fixture of claim 1 further comprising a third wall portion integrally connected and extending between the sidewall portions in a manner facilitating the formation of a second air flow cavity extending along the interior chamber in opposed relation to the first air low cavity.

3. The LED light fixture of claim 2 wherein the serrated surface region of each of the sidewall portions extends from about the first wall portion to about the third wall portion.

4. The LED light fixture of claim 2 further comprising at least one Li-Fi transmission component disposed within the interior chamber of the channel member.

5. The LED light fixture of claim 2 further comprising an identically configured pair of end caps attached to respective ones of an opposed pair of ends defined by the channel member, each of the end caps including openings adapted to facilitate air flow through each of the first and second airflow cavities.

6. The LED light fixture of claim 2 wherein the reflector portion comprises an identically configured pair of arcuate side sections which protrude from the first surface of the support portion in opposed relation to each other, each of the side sections defining a generally concave interior surface, with the interior surfaces being sized and configured that light emitted from the LED strip will bounce therefrom no more than once prior to exiting the reflector portion.

7. The LED light fixture of claim 1 wherein the LED strip includes a plurality of LEDs and MOSFETs attached to a common core.

8. The LED light fixture of claim 1 further comprising at least one Li-Fi transmission component disposed within the interior chamber of the channel member.

9. The LED light fixture of claim 1 wherein the reflector portion comprises an identically configured pair of arcuate side sections which protrude from the first surface of the support portion in opposed relation to each other, each of the side sections defining a generally concave interior surface, with the interior surfaces being sized and configured that light emitted from the LED strip will bounce therefrom no more than once prior to exiting the reflector portion.

10. The LED light fixture of claim 1 further comprising an identically configured pair of end caps attached to respective ones of an opposed pair of ends defined by the channel member, each of the end caps including at least one opening adapted to facilitate air flow through the first airflow cavity.

11. The LED light fixture of claim 1 wherein the channel member is fabricated from extruded aluminum.

12. An LED light bar, comprising:
an elongate channel member defining:
an elongate support portion which defines a first surface and an opposed second surface, at least a portion of the second surface having a serrated configuration of increased surface area;
an identically configured pair of elongate flange portions integrally connected to and extending along the support portion in opposed relation to the each other, each of the flange portions defining a coupling arm segment which at least partially overhangs the first surface of the support portion;
an identically configured pair of elongate rail portions integrally connected to the respective ones of the flange portions and each defining an exteriorly presented surface which includes a serrated surface region;
an opposed pair of sidewall portions integrally connected to respective ones of the rail portions, each defining an exteriorly presented surface which includes a serrated surface region; and
at least first and second wall portions integrally connected and extending between the sidewall portions in a manner facilitating the formation of an interior chamber, and at least a first air flow cavity extending between the support portion and the interior chamber;
an LED strip attached to and the channel member and extending along at least portion of the first surface of support portion thereof, the LED strip being maintained in engagement to the support portion by the coupling arm segments of the flange portions.

13. The LED light bar of claim 12 further comprising a third wall portion integrally connected and extending between the sidewall portions in a manner facilitating the formation of a second air flow cavity extending along the interior chamber in opposed relation to the first air low cavity.

14. The LED light bar of claim 13 wherein the serrated surface region of each of the sidewall portions extends from about the first wall portion to about the third wall portion.

15. The LED light bar of claim 13 further comprising at least one Li-Fi transmission component disposed within the interior chamber of the channel member.

16. The LED light bar of claim 13 further comprising an identically configured pair of end caps attached to respective ones of an opposed pair of ends defined by the channel member, each of the end caps including openings adapted to facilitate air flow through each of the first and second airflow cavities.

17. The LED light bar of claim 12 wherein the LED strip includes a plurality of LEDs and MOSFETs attached to a common core.

18. The LED light bar of claim 12 further comprising at least one Li-Fi transmission component disposed within the interior chamber of the channel member.

19. The LED light bar of claim 12 further comprising an identically configured pair of end caps attached to respective ones of an opposed pair of ends defined by the channel member, each of the end caps including at least one opening adapted to facilitate air flow through the first airflow cavity.

20. The LED light bar of claim 12 wherein the channel member is fabricated from extruded aluminum.
